(19) United States
(12) Patent Application Publication
(10) Pub. No.: US 2006/0192055 A1
(43) Pub. Date: Aug. 31, 2006

(54) Inflatable wing

(76) Inventor: Alex Shogren, Delray Beach, FL (US)

Correspondence Address: Mark D. Bowen;Stearns Weaver Miller Weissler, Alhadeff & Sitterson, P.A., 200 East Las Olas Blvd., Suite 2100, Fort Lauderdale, FL, 33301, US

(21) Appl. No.: 11/348,512

(22) Filed: Feb. 6, 2006

Related U.S. Application Data
(60) Provisional application No. 60/650,248, filed on Feb. 4, 2005.

(51) Int. Cl. B64D 17/02

(52) U.S. Cl. 244/145

(57) ABSTRACT

A bladderless inflatable kite usable to propel humans, wherein the kite foregoes some or all conventional bladder structures. A bladderless or partially bladderless inflatable kite reduces the weight, and reduces problems associated with rubbing between the bladders and the outside layer, or the like. A bladderless kite structure is formed of a material that comprises a laminated mix of carbon and polymer filaments into a laminant structure wherein unidirectional prepreg tapes of in-line plasma treated fibers are spread to mono-filament level films and bonded with a UV absorbing titanium resin.

### CROSS REFERENCE TO RELATED APPLICATIONS

This application claims the benefit of provisional U.S. Patent Application Ser. No. 60/650,248, filed on Feb. 4, 2005.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to inflatable wings, and more specifically to kites usable to propel humans for sport and entertainment.

2. Description of Related Art

Inflatable kites are used in a myriad of industries including kite-boarding. Inflatable traction kites in particular include an outside layer defining the kite shape and an inside bladder layer that seals the air or gas used to define the kite's shape.

U.S. Pat. No. 4,708,078 to Legaignoux et al., discloses a basic design for a leading edge inflatable (“LEI”) kite. Legaignoux discloses an inflatable leading edge having an inflatable armature covered by a flexible envelope.

U.S. Patent Application Publication No. 2004/0188567, in the name of Logosz, discloses an aerodynamic wing with a leading edge inflatable strut and at least one inflatable rib strut, wherein the struts are provided with a connection air pathway that allows the leading edge strut to act as a manifold for the inflation of the connected rib struts. A valve mechanism is provided for selectively isolating the connected rib strut from the leading edge strut. U.S. Patent Application Publication No. 2004/0195435, in the name of Logoz, discloses an aerodynamic wing formed by a flexible canopy with integrated inflatable, elastically deformable members integrated into the lifting surface. Preferably, the elastically deformable member extends and contracts the lifting surface depending on forces experienced by the wing. In one embodiment, the wing comprises an inflatable leading edge kite. Logoz discloses that use of a separate bladder may be avoided in conditions wherein the casing is sufficiently airtight. Logoz, however, fails to identify any material that is both airtight, strong, and sufficiently lightweight to allow for the formation of a suitable bladderless traction kite.

Accordingly, it has been found that a significant problem associated with the fabrication of bladderless kites involves choice of material. More particulary, there exists a need for a material that is sufficiently airtight, lightweight, and strong to be suitable for use in fabricating a traction kite having desired performance characteristics.

### BRIEF SUMMARY OF THE INVENTION

A need exists for a light weight reliable, effectively supported structure for a kite. Accordingly, the present disclosure includes a kite usable to propel humans, wherein the kite foregoes some or all conventional bladder structures. For example, a bladderless or partially bladderless inflatable kite reduces-the weight, and reduces problems associated with rubbing between the bladders and the outside layer, or the like. A significant aspect of the present invention relates to fabrication of a bladderless kite from a synthetic material containing a mix of carbon and polymer filaments.

Accordingly, it is an object of the present invention to provide improvements in the art of traction kite design.

Another object of the present invention is to provide a bladderless traction kite design.

Still another object of the present invention is to utilize a synthetic material containing a mix of carbon and polymer filaments in the formation of a bladderless traction kite.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 illustrates a simplified inflatable kite structure with a canopy.

FIG. 2 illustrates an exemplary inflatable kite structure of the disclosure without the associated canopy structure.

FIG. 3 illustrates a cross-sectional view of a prior art inflatable kite structure having a bladder and envelope.

FIG. 4 illustrates a cross-sectional view of a kite structure in accordance with the present invention.

FIG. 5 is a cross-sectional view of a bladderless teardrop shaped wing having an inflatable leading edge airfoil.

FIG. 6 is a cross-sectional view of a bladderless fully inflatable wing.

FIG. 7 is a perspective view of a fully inflatable bladderless wing in accordance with the present invention.

FIG. 8 is a perspective view of a bladderless teardrop shaped wing having an inflatable leading edge airfoil in accordance with the present invention.

### DETAILED DESCRIPTION OF THE INVENTION

A kite, more preferably a traction kite, comprises an envelope that forms the canopy and an inflatable frame that may be filled with air, gas, or the like. In an embodiment, the frame and canopy form the shape for the kite. In other embodiments, the shape can also be supported by specific additional solid parts like battens and/or molded frames that are either permanently connected to the kite structure or are inserted separately. Support may be from ram air cells which fill with air as the kite moves through the air. The inflatable structure helps support the shape of the kite and/or helps define its profile, In addition, the inflatable structure is preferably formed without a bladder, however, as one of skill in the art would recognize, portions may be made with a bladder while other portion; are made without a bladder. The canopy or envelope may cover and/or encase the structure. In other embodiments, the structure can be covered fully or only partly.

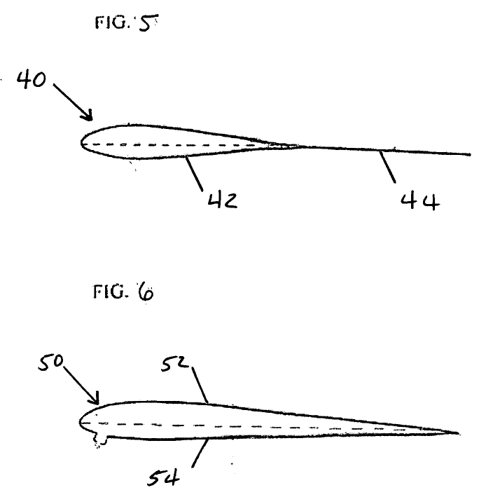

According to the prior art, an inflatable structure of a kite with bladders is often created by 2 parts: one part that defines the shape and keeps the pressure (exterior layer), and the second part is the inner bladder (interior layer) that keeps the air enclosed. FIG. 3 illustrates a cross-sectional view of an inflatable kite structure 20 in accordance with the prior art. More particularly, the prior art kite structure 20 includes an inner layer 22 that provides an airtight bladder for maintaining the air and/or gas enclosed and under pressure. Kite structure 20 further includes an outer layer 24 that defines the shape of the kite and maintains the bladder under pressure. FIG. 4 illustrates a cross-sectional view of a kite structure in accordance with the present invention, generally referenced as 30, wherein a single layer holds the pressure and shape as well as enclosing the air and/or gas pressure.

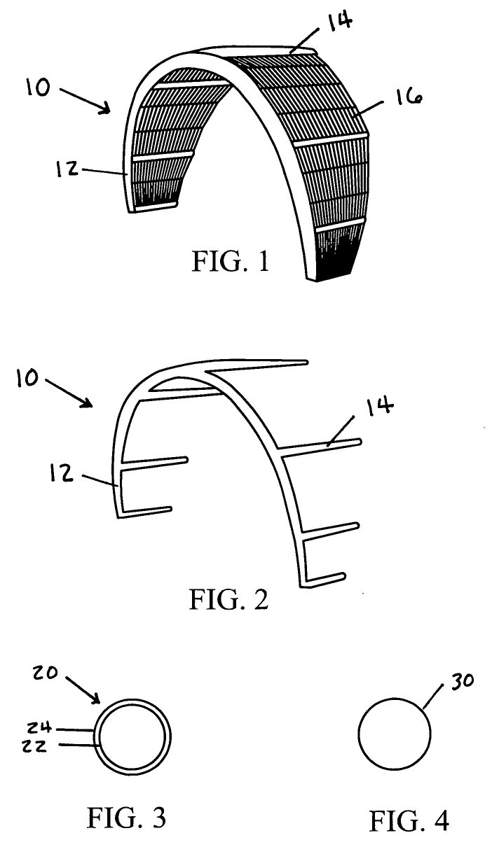

FIG. 1 illustrates a simplified inflatable bladderless kite, generally referenced as 10, in accordance with the present invention. Bladderless kite 10 includes an inflatable leading edge 12, inflatable spars 14 connected to said leading edge, and structure with a canopy 16. FIG. 2 illustrates an exemplary inflatable kite structure, including leading edge 12 and spars 14, without the canopy structure normally associated therewith.

The bladderless inflatable structure is formed by fabric pieces that are assembled together, and/or by special formed fabric parts that creates the desired shape. The seams are preferably adhesively sealed. Other sealing methods include epoxy, heat sealing, stitching, tape, or the like. The fabric and seam manufacture limits the amount of air or gas allowed to pass there through. Preferably, this amount is kept as low as possible.

A significant aspect of the present invention involves forming a bladderless kite structure of a material that comprises a laminated mix of carbon and polymer filaments. More particularly, the present invention contemplates forming a bladderless kite structure of a material identified as “Cuben Fiber” a laminate material wherein unidirectional prepreg tapes of in-line plasma treated fibers are spread to mono-filament level films identified as CUBEN FIBER, and bonded with a UV absorbing titanium resin. CUBEN FIBER is a non-registered trademark of Cuben Fiber Corporation. Cuben Fiber is created by a complex fabric creating process. For a start, it is made of many layers of untwisted filaments laid in a multitude of directions. Once the fabric has been engineered, it is loaded into an autoclave and baked under high heat and pressure until the individual filaments and film become one, making it extremely strong and stretch resistant for its weight.

U.S. Pat. Nos. 5,470,632, and 5,333,568, each issued to Meldner et al., the subject matter of which are incorporated herein by referenced disclose a compostite materials for fabrication of sails and other articles, known as Cuben Fiber. The material is a reinforced laminate for use in sails or other flexible sheet or membrane applications utilizes a pull-truded thin lightweight reinforcing sheet of unidirectional extruded monofilaments in which the reinforcing sheet or sheets form one or more uni-tapes laminated to a polymer film such as Mylar, or other extended sheet of material. The monofilaments are uniformly embedded in the uni-tape via an elastomeric polymer matrix, with the reinforcing sheet, when incorporated into sails via lamination resulting in sails with reinforcing monofilaments having diameters 5 times less than conventional strands or threads. The use of small diameter monofilaments greatly increases the monofilament-over-monofilament crossover density, resulting in a dramatic increase in shear strength, and Youngs' Modulus, with an accompanying dramatic decrease in weight. In one embodiment the improvement in specific modulus over conventional sail laminates is about six-fold. For example, at only one-third the weight, stretch resistance is two times better. In a preferred embodiment, autoclaving is used in the lamination process to rid the laminate of voids which dramatically reduce shear strength by as much as 30 percent. Alternative void-free laminating processes include a silicone interliner/heated platen technique.

An inflatable wing in accordance with the present invention is particularly suitable for use in the sport of kite boarding. More particularly, a bladderless kite formed in accordance with the present invention significantly improves upon currently available kites by providing the lightest, best performing and most aerodynamically efficient kite ever produced. The bladderless design allows for improved aerodynamic efficiency, and when coupled with the reduced weight yields amazing but controllable power. As a result kite board enthusiasts can now use smaller kites than they normally would for the wind conditions.

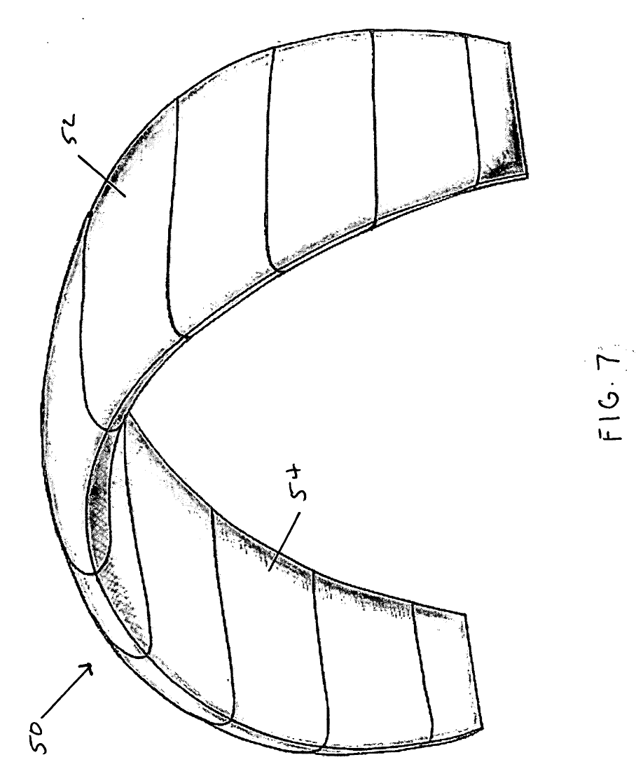

FIG. 5 is a cross-sectional view of a bladderless teardrop shaped wing, generally referenced as 40, having an inflatable leading edge. More particularly, wing 40 includes an inflatable leading edge 42, and a non-inflatable canopy 44 connected to leading edge 42. FIG. 8 is a perspective view of bladderless teardrop shaped wing 40 having an inflatable leading edge 42, and a non-inflatable canopy 44, that may be additionally supported by inflatable spars 46, suitable for use in a kiteboarding application.

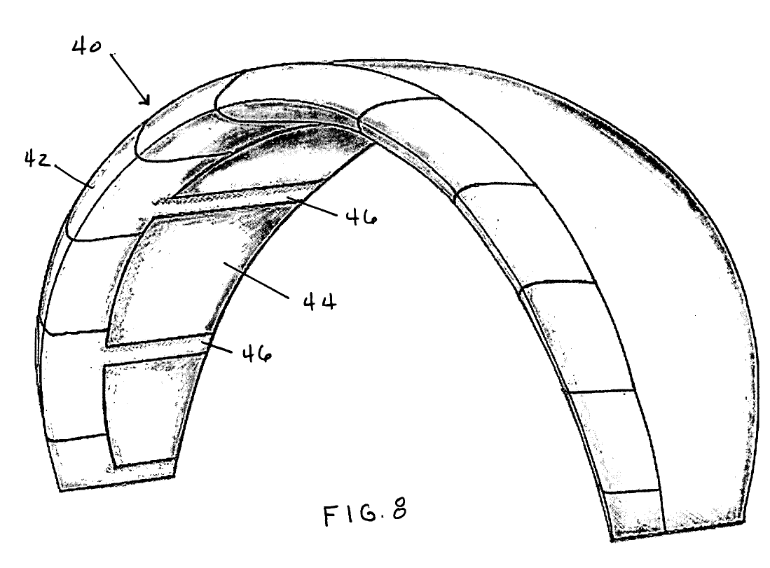

FIG. 6 is a cross-sectional view of a bladderless fully inflatable wing, generally referenced as 50, having a fully inflatable airfoil. More particularly, wing 50 includes an inflatable airfoil having a top surface 52 and a bottom surface 54. FIG. 7 is a perspective view of a fully inflatable wing 50 suitable for use in a kiteboarding application.

When adapted for use in kiteboarding, the bladderless design allows for performance enhancements, such as improved turning and a high level of precise rider feedback. Furthermore, steering input by the rider is immediate, there is no lag in the kite as experienced with prior art designs. Because the bladderless design is so responsive, fast, and aerodynamically efficient, it jumps higher and hangs longer than conventional kites. For example, it has been found that a bladderless kite made in accordance with the present invention is capable of jumping an extra 5-10 feet higher, while providing extended hang time. More particularly, such a kite jumps like a kite 3-5 square meters smaller and hangs like a kite 3-5 square meters larger.

Because Cuben Fiber is up to 10 times stronger than traditional kite materials, a kite made in accordance with the present invention is one of the most durable kite on the market. Additionally, because Cuben Fiber does not stretch, the kite will retain its performance characteristics over time.

Traditionally, large leading edge tube diameters were necessary for big kites in light wind to support the shape of the kite, but the drag created by these huge inflatable structures is immense. This inefficiency yields poor light wind performance, particularly in conditions wherein wind speeds were less than 12 knots. As a result of the reduced diameter leading edge and struts made possible by the bladderless design, the aerodynamic wing yields more power and less drag making riding powered in 5-8 knots possible.

The advantages in aerodynamic design and use of lightweight material yields delivers an increased wind range with amazing low end power, while further delivering an enlarged “sweet spot” in the range. More particularly, traditional kites have a 3-5 knot sweet spot meaning one is perfectly powered in that 3-5 knot wind range. A kite made in accordance with the present invention, however, has been found to have a 14-20 knot range and an 8-10 knot sweet spot thereby providing better performance throughout the range.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. An inflatable wing, comprising:
an upper wing surface and a lower wing surface constructed from a flexible material, the upper and lower surfaces being joined along their edges to form an envelope having a leading edge and a trailing edge;
at least two control lines for restraining and controlling the wing;
wherein said envelope includes at least one bladderless cells which cooperate with the envelope to define the shape of the wing.

2. A wing in accordance with claim 1, wherein said flexible material comprises a synthetic material containing a mix of carbon and polymer filaments.

3. A wing in accordance with claim 2, wherein said synthetic material comprises a laminate material having unidirectional prepreg tapes of in-line plasma treated synthetic fibers are spread to mono-filament level films and bonded with a UV absorbing titanium resin.

4. A wing in accordance with claim 1, wherein said wing has two control lines.

5. A wing in accordance with claim 4, wherein each control line is connected to each end of the envelope by way of two or more bridal lines.

6. A wing in accordance with claim 1, wherein said wing has four control lines, each wing tip having a control line connected at or near its leading edge and a control line connected at or near its trailing edge.

7. A wing in accordance with claim 1, wherein the upper and lower surfaces near each wing tip are adapted so as to impart a residual twist that increases an angle of incidence on wing tips while flying.

8. A wing in accordance with claim 1, wherein access to said at least one bladderless cell is through one or more valves.

9. A wing in accordance with claim 1, wherein said at least one bladderless cell comprises a leading edge.

10. A wing in accordance with claim 9, further including a plurality of bladderless inflatable spars in fluid communication with said leading edge.

11. An inflatable wing, comprising:
an upper wing surface and a lower wing surface constructed from a flexible material, said upper and lower surfaces being joined along edges thereof to form an envelope having a leading edge and a trailing edge;
at least two control lines for restraining and controlling the wing;
wherein said envelope includes at least one bladderless cell which cooperates with the envelope to define the shape of the wing;
said flexible material containing a mix of carbon and polymer filaments.

12. An inflatable wing in accordance with claim 11, wherein said flexible material comprises a laminate material having unidirectional prepreg tapes of in-line plasma treated synthetic fibers spread to mono-filament level films and bonded with a UV absorbing titanium resin.
